(19) United States
(12) Patent Application Publication
(10) Pub. No.: US 2013/0241790 A1
(43) Pub. Date: Sep. 19, 2013

(54) LARGE-AREA BROADBAND SURFACE-WAVE ANTENNA

(71) Applicants: Laurent Prioul, Rennes (FR); Philippe Piole, Cesson-Sevigne (FR); Sébastien Palud, Rennes (FR); Pierre-Yves Jezequel, Thorigne-Fouillard (FR); Jean-Yves Laurent, Rennes (FR)

(72) Inventors: Laurent Prioul, Rennes (FR); Philippe Piole, Cesson-Sevigne (FR); Sébastien Palud, Rennes (FR); Pierre-Yves Jezequel, Thorigne-Fouillard (FR); Jean-Yves Laurent, Rennes (FR)

(73) Assignee: TDF, Montrouge (FR)

(21) Appl. No.: 13/877,430

(22) PCT Filed: Oct. 6, 2011
(86) PCT No.: PCT/EP2011/067518

§ 371 Date: Jun. 5, 2013

(30) Foreign Application Priority Data
Oct. 7, 2010 (FR) 1058165

(51) Int. Cl. H01Q 7/00

(52) U.S. Cl. CPC H01Q 7/00
USPC 343/843

(57) ABSTRACT

The antenna comprises a metal excitation loop (B1) to be positioned at a height (h) of at least about 1 above the surface (SM) of a conducting medium (M) and a supply means (A, L1n) to be connected to the conducting medium. The perimeter of the loop is about one half of the operating wavelength, namely λ/2, in length. The loop comprises two approximately parallel portions (I1p-I1n, S1) which are at most about λ/50 apart and are capable of extending approximately parallel to said surface in a plane approximately perpendicular to said surface, currents of opposite direction flowing through said portions. The closest portion to said surface includes an aperture between ends (E1p, E1n) of the loop that are connected to the supply means. The antenna is better protected from space waves and it can be reduced in size by being folded up.

The present invention relates to a large-area antenna for transmitting and or receiving surface waves in a broad frequency band, including in particular some or all of the low, medium and high frequencies of between approximately 30 kHz and approximately 30 MHz, or kilometre, hectometre and decametre wavelengths.

The antenna may be incorporated for example into a high-power transmission system, in particular for broadcasting radio or television programme signals, a surface-wave radar system or a reception and interception system.

Currently, large-scale transmission masts are used to transmit high powers in the hectometre bands. These masts have the drawback of being expensive, requiring a large secure area for the installation thereof, and being unsightly and obtrusive. They are not optimised for broadcasting which basically uses surface waves.

There are very few antennae which purely use a surface wave as a propagation medium. This is demonstrated by the fact that current surface-wave radar systems use whip or biconical antennae, which are ill-suited to radar applications.

Transmission masts, and in general all vertical polarisation antennae, for example whip or biconical antennae, basically generate a space wave field and are expensive and obtrusive.

Patent application EP 1 594 186 A1, filed by the Applicant, discloses a large-scale ground antenna for transmitting a kilometre or hectometre surface wave. This antenna comprises a metal earth plane, a metal excitation loop, and a metal connection element. The earth plane is buried horizontally, close to and below the surface of the ground. The excitation loop is more than approximately 25 m long for the kilometre and hectometre wavelengths, is open between the two ends, and extends parallel to the earth plane and horizontally above the surface of the ground at a height of more than approximately 2 m above the earth plane. The metal connection element is perpendicular to the loop and connects one of the ends of the excitation loop to the earth plane. The excitation loop and the connection element are each formed by at least one thin cylindrical element.

The discontinuity between the air and the ground, located on and in the ground at the periphery of the antenna, between the ground and the metal earth plane, on the one hand, and the ground without the metal earth plane, on the other hand, promotes the propagation of a vertical-polarised omnidirectional ground wave. The opening in the excitation loop is small by comparison with the length of the loop so as virtually to eliminate any horizontal electric field component at the surface of the ground. The ground wave is brought about by injecting high currents into the ground, as a result of a low ohmic resistance of the antenna, without any lateral transmission of a space we compared to a mast antenna.

Although patent application EP 1 594 186 A1 aims to promote the propagation of surface waves considerably and to minimise the transmission of a space wave by the transmission masts, so as to prevent the antenna from being coupled in particular to constructions close to the antenna above the ground, the ground antenna generates a non-negligible space wave for angles close to the normal to the plane of the ground. This space wave has a much lower power than the surface wave, and is vanishingly a few tens of kilometres above the surface of the ground. Depending on the frequency bands, the space wave may reflect off layers of the ionosphere and lead to fading phenomena in combination with a surface wave. When the antenna is in transmitting operation, the space wave may interfere with useful signals received from the ionosphere by other antennae. Conversely, the recovery of space waves may interfere with the receiving operation of the antenna.

Moreover, the ground antenna takes up a large surface area and has a relatively narrow pass band.

The object of the present invention is to overcome the various problems mentioned above, and in particular to provide a large-scale surface-wave antenna which has increased ionospheric protection over short and medium distances, and a favourable construction for reducing the area of the antenna in at least one dimension in space and for broadening the pass band.

To achieve this object, a surface-wave antenna, comprising a metal excitation loop to be positioned at a height of at least approximately 1 m above the surface of a conducting medium and a supply means to be connected to the conducting medium, the loop being of a length of approximately λ/2 and λ representing the operating wavelength of the antenna, is characterised in that the excitation loop comprises two substantially parallel portions which are at most approximately λ/50 apart, can extend substantially parallel to the surface of the conducting medium in a plane substantially perpendicular to said surface, and can be flowed through by currents of opposite directions, the closest portion to said surface having an opening between ends of the loop which are connected to the supply means.

Said two portions of the excitation loop according to the invention are lower and upper portions with respect to the surface of the conducting medium, such as the earth or the sea, and may, approximately speaking, form halves of the loop, the remaining portions of the loop each being of a length of at most approximately λ/50. The vast majority of the excitation loop is thus formed by one or more pairs of lower and upper portions, each extending in a plane substantially perpendicular to the surface of the conducting medium, the lower and upper portions of a pair being arranged in the loop so as to receive currents of opposite directions. These conditions strongly promote the propagation of a vertical-polarised omnidirectional ground wave, known as a surface wave, at the discontinuity between the air and the conducting medium, at the periphery of the loop, to the detriment of any space wave along a central zenithal axis of the loop. The antenna thus transmits very little space wave in the direction of a central zenithal axis of the antenna, in particular because currents of opposite directions, that is to say effectively in phase opposition, are flowing in the large-scale, parallel lower and upper portions. This greatly reduces the contribution of horizontal field components for angles close to the central zenithal axis of the antenna.

The opening of the excitation loop is very small by comparison with the perimeter of the loop, so as virtually to eliminate any electric field component which is parallel to the surface of the conducting medium, and thus horizontal.

Like the antenna according to patent application EP 1 594 186 A1, the antenna according to the invention is very unobtrusive and resistant to any wind, blast, lightning, earthquake or explosion. The present antenna also has a very low radar echo surface (RES). According to one embodiment, the excitation loop may be planar and contained in a plane substantially perpendicular to the surface of the conducting medium. For example, the excitation loop may be rectangular and comprise two long sides formed by the two lower and upper portions of a length of at most approximately λ/4.

According to one aspect of the invention, the size of the antenna can be reduced in the longitudinal directions of the antenna by way of one or more folds of long portions of the excitation loop in planes perpendicular to the surface of the conducting medium. In this case, the excitation loop may be divided, approximately speaking, into two half-loops, which are superposed on two substantially parallel planes to the surface of the conducting medium and at a distance of at most λ/50 and which each have two substantially parallel portions which can be flowed through by currents of opposite directions. Each of the half-loops may comprise more than two substantially parallel portions, it being possible for two adjacent portions in each half-loop to be flowed through by currents of opposite directions and for two superposed portions of the half-loops to be flowed through by currents of opposite directions.

According to certain “folded” antenna embodiments, the excitation loop may be circumscribed on a parallelepiped having large faces substantially parallel to the surface of the conducting medium. The parallelepiped may be right. For example, each of the half-loops may extend in a zigzag on one of the large faces. According to another example, each of the half-loops may comprise two flat rectangular spirals having opposite directions and a shared centre and extending on one of the large faces. According to another folded antenna embodiment, the excitation loop is circumscribed on a cylinder having bases substantially parallel to the surface of the conducting medium, and each of the half-loops comprises two flat circular spirals having opposite directions and a shared centre and extending on one of the bases.

So as to reduce the coupling in particular between substantially parallel lower and upper portions or substantially parallel portions in a half-loop, and thus more generally between the superposed half-loops, two substantially parallel, superposed, adjacent portions of the excitation loop may be at a distance of at least approximately λ/200.

So as to broaden the pass band of the antenna, the antenna may comprise at least one intermediate metal element, which is connected to lower and upper portions of the excitation loop, which are superposed in a plane which may be substantially perpendicular to the surface of the conducting medium and is located close to short sides of the excitation loop. which are substantially perpendicular to the superposed portions.

As regards the supply means of the antenna, it may comprise a power supply device such as a transmission device if the antenna is in transmitting operation, or a receiving device if the antenna is in receiving operation, and one or two substantially vertical metal connection elements connecting the supply means to the propagation means. According to a first embodiment, the supply means only comprises one metal connection element, possibly including e terminal impedance, for connecting the excitation loop to the conducting medium; the terminals of the power supply device are connected to the ends of the loop, and the metal connection element has one end connected to the negative terminal of the supply device and another end which can be connected to the conducting medium. According to a second embodiment, the supply means comprises two metal connection elements for connecting the excitation loop to the conducting medium; one metal connection element has one end connected to one of the ends of the loop and another end which can be connected to the conducting medium, the power supply device has a positive terminal connected to the other end of the loop, and another metal connection element, which may include a terminal impedance, has one end connected to a negative terminal of the supply device and another end which can be connected to the conducting medium.

When the conducting medium has a low electrical conductivity, the invention remedies this, so as to maintain the surface-wave radiation properties of the antenna, by burying a metal earth element, having a surface area at least equal to the projection of the surface of the excitation loop onto the surface of the conducting medium, close to and below the surface of the conducting medium. One metal connection element, which is the only metal connection element in accordance with the first embodiment and may be either of the metal connection elements in accordance with the second embodiment, thus has the end thereof able to be connected to the conducting medium, which is connected to the metal earth element.

Further features and advantages of the present invention will become clearer from reading the following description of a plurality of embodiments of the invention, given by way of non-limiting example, with reference to the corresponding appended drawings, in which:

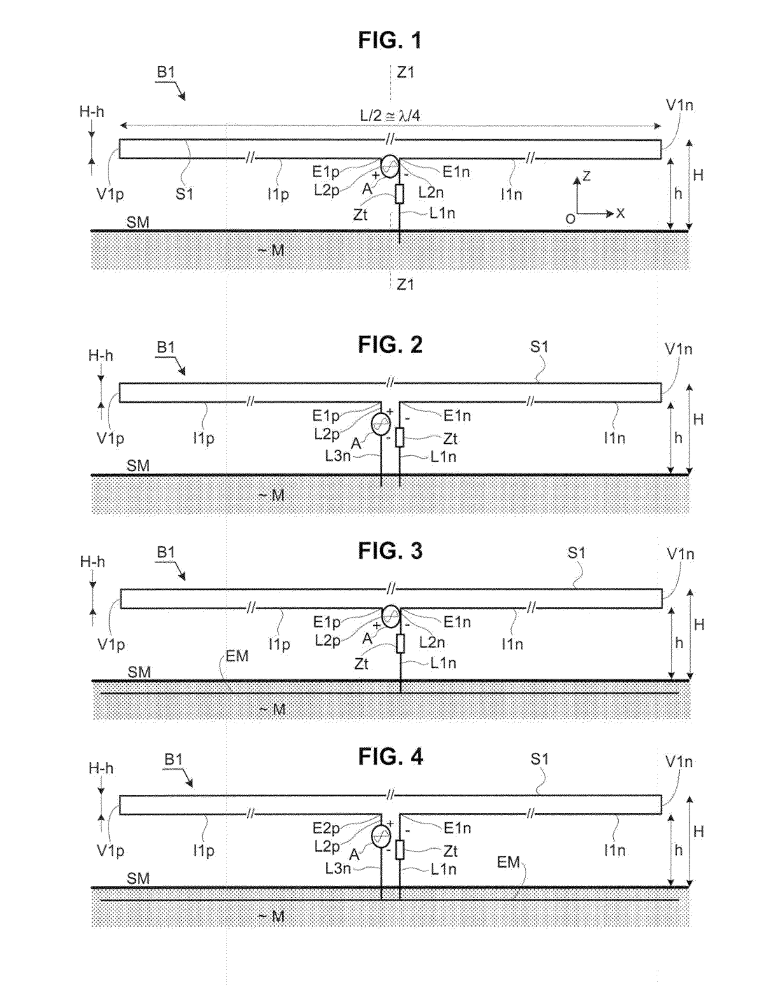

FIG. 1 is a schematic vertical elevation of an antenna comprising a rectangular loop and a supply circuit in accordance with a first embodiment of the invention, having a single connection element connected to a conducting medium of high electrical conductivity;

FIG. 2 is a schematic vertical elevation of an antenna comprising a rectangular loop in accordance with a first embodiment of the invention and a supply circuit in accordance with a second embodiment of the invention, having two connection elements connected to a conducting medium of high electrical conductivity;

FIGS. 3 and 4 are schematic vertical elevations of an antenna in accordance with the variants shown in FIG. 1 and 2 respectively, for a conducting medium of low electrical conductivity;

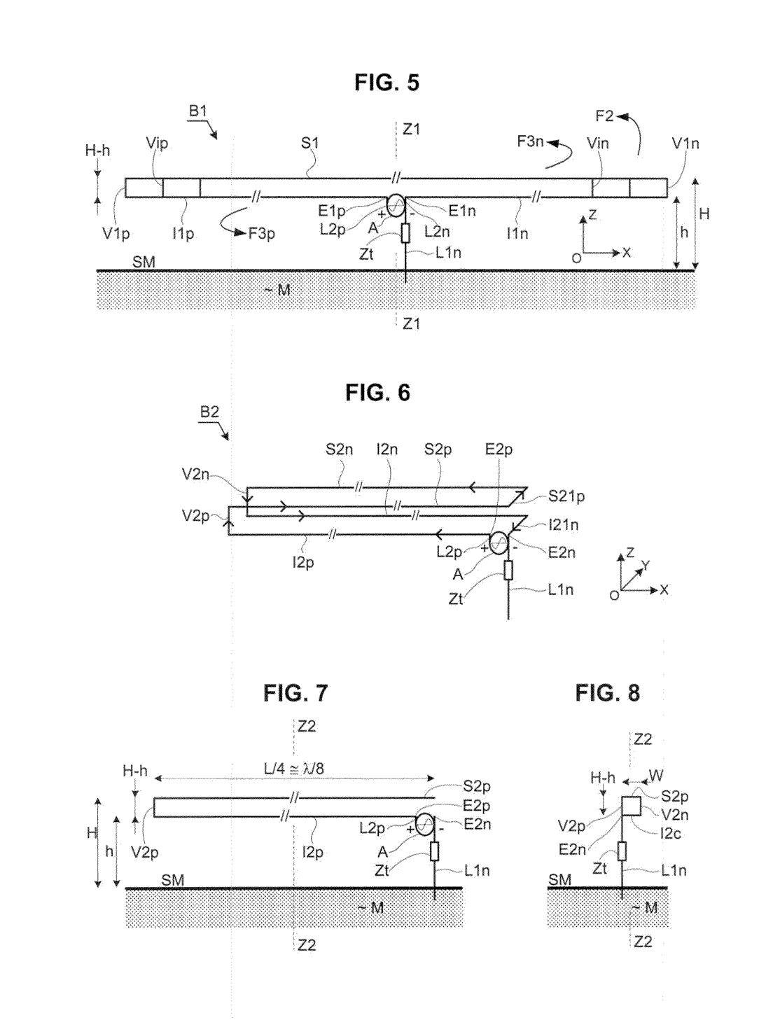

FIG. 5 is a schematic vertical elevation of an antenna in accordance with a further variant of the antenna shown in FIG. 1 intended to broaden the pass band of the antenna;

FIG. 6 is a schematic perspective view of an antenna comprising a loop in accordance with a second embodiment of the invention, which is intended to reduce the longitudinal size of the antenna by comparison with the first embodiment of the loop by folding along a central zenithal loop axis of FIG. 1;

FIGS. 7 and 8 are a front elevation and a view from the right-hand side respectively, along perpendicular vertical planes XOZ and YOZ, of the antenna shown in FIG. 6;

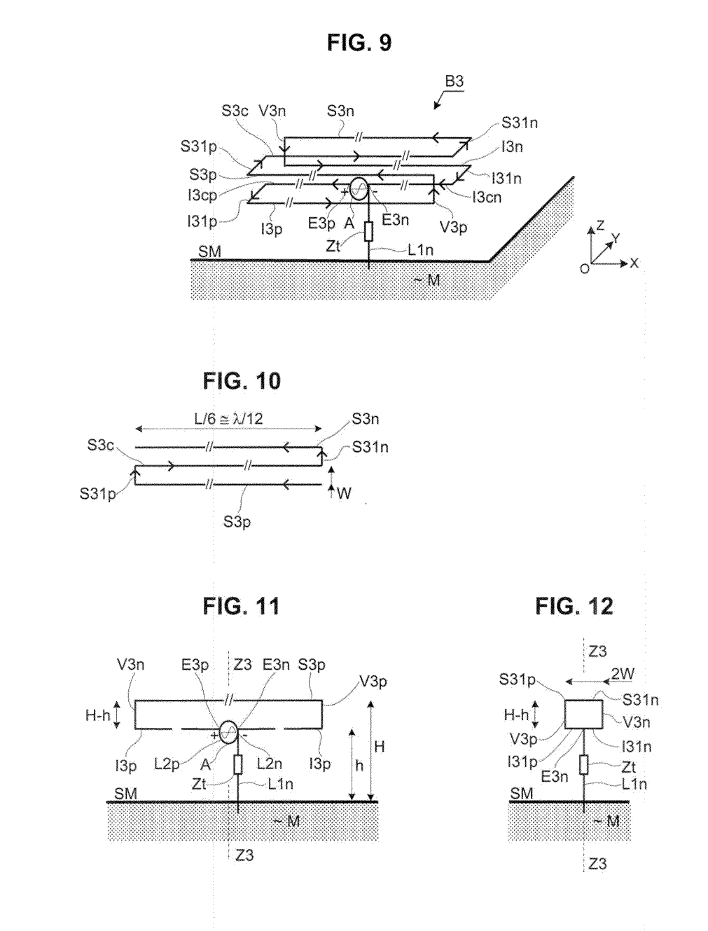

FIG. 9 is a schematic perspective view of an antenna comprising a folded loop in accordance with a third embodiment of the invention, intended to reduce the longitudinal size of the antenna further;

FIGS. 10, 11 and 12 are a view from above, a front elevation and a view from the right-hand side respectively of the antenna shown in FIG. 9;

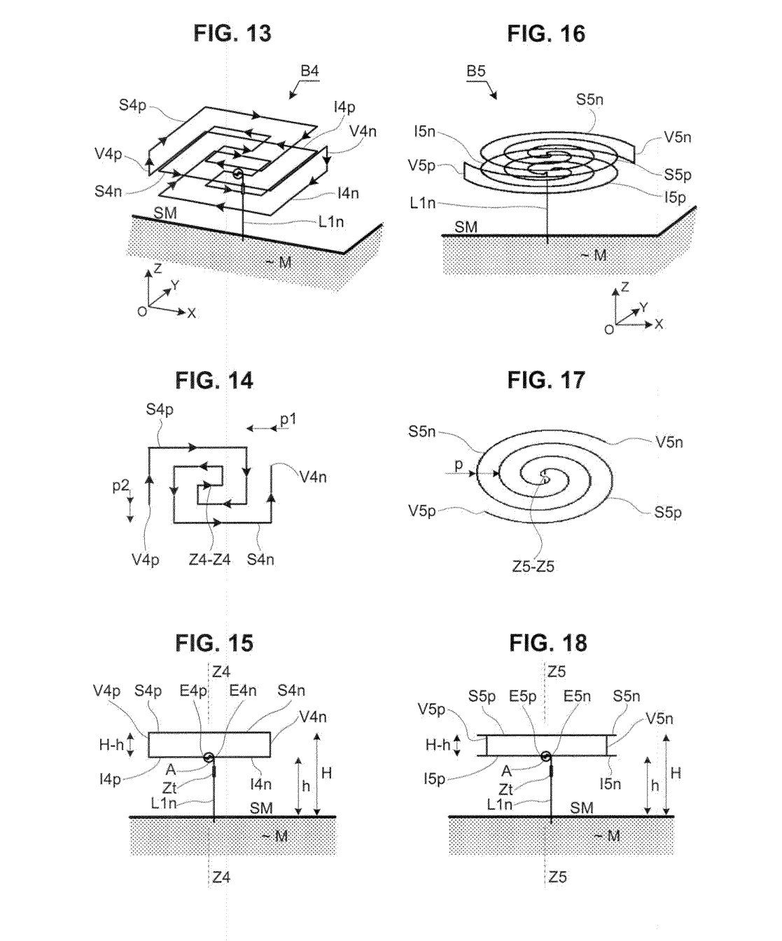

FIG. 13 is a schematic perspective view of an antenna comprising a loop contained in a parallelepiped and folded along Archimedean spirals in accordance with a fourth embodiment of the invention;

FIGS. 14 and 15 are a view from above and a front elevation view respectively of the antenna shown in FIG. 13;

FIG. 16 is a schematic perspective view of an antenna contained in a cylinder and folded along Archimedean spirals in accordance with a fifth embodiment of the invention; and

FIGS. 17 and 18 are a view from above and a front elevation view respectively of the antenna shown in FIG. 16.

Referring to FIG. 1, a surface-wave antenna according to the invention can operate at a useful transmission or reception wavelength λ. The useful wavelength λ corresponds to the central frequency of the pass band of the antenna, which corresponds at least in part to kilometre and/or hectometre and/or decametre wavelengths.

The antenna in accordance with the first embodiment basically comprises a substantially vertical metal excitation loop B1 and a supply circuit comprising a power supply device A and a substantially vertical metal conductive connection element L1n which connects the excitation loop to a conducting medium M of surface SM. The term “substantially vertical” means that the excitation loop or the connection element may extend in a plane perpendicular to the surface SM or in an oblique plane at an angle of a few degrees to a plane perpendicular to the surface SM; the terms “substantially horizontal”, “substantially parallel” and “substantially perpendicular”, as used in the present description, are of a similar meaning in relation to a horizontal plane or line, or in relation to a determined plane or straight line.

The conducting medium M acts as a propagation medium for surface waves transmitted or received by the antenna. The medium M may be of a high electrical conductivity, like the sea, a salt marsh or a salt lake, or a lower electrical conductivity, like the earth or sand.

In the rest of the description, a reference sign in the drawings comprising the letter p or n respectively denotes an element or portion of the excitation loop connected to the positive or negative terminal respectively of the supply device A or located on the side thereof along the excitation loop.

The metal excitation loop B1 extends substantially vertically above the surface SM at a height between h and H. In accordance with the embodiment shown in FIG. 1, the loop B1 is rectangular and consists of two substantially horizontal long sides I1p-I1n and S1 and two much shorter substantially vertical sides V1p and V1n. The lower long side I1p-I1n is located at the height h with respect to the surface SM. The upper long side S1 is located at the height H with respect to the surface SM. The difference in height H−h is the length of the short sides V1p and V1n, which is at least equal to approximately λ/200 so as to reduce the coupling between the long sides I1p-I1n and S1 of the loop, which creates a transmission mode for a two-wire line, reducing the efficiency of the antenna. So as to radiate very few space waves in the direction of a central zenithal axis Z1-Z2 of the loop B1, the difference in height H−h is at most equal to approximately λ/50, in such a way that the long sides I1p-I1n and S1 of the loop B1 are close to one another and the currents therein are of opposite directions. As will be seen from the description of the other antenna embodiments, the shape of the loop is not limited to a rectangle, and is determined as a function of the purity of the substantially vertical polarisation of a surface wave and the omnidirectionality at the surface SM which are desired for the antenna.

The height H is at least approximately 2 m for kilometre and hectometre waves and at least approximately 1 m for decametre waves. The average distance (H+h)/2 between the loop B1 and the surface SM must not be too large, so as to couple as much radioelectrical energy as possible at the surface SM, in such a way that the antenna radiates a surface wave above the surface SM. The heights h and H are not necessarily constant over the length of the loop, just as the difference H−h is not necessarily constant; as a result, the long sides I1p-I1n and S1 are “substantially mutually parallel”, and each of them is “substantially parallel” to the surface SM. The discontinuity between the air and the conducting medium M at the periphery of the excitation loop promotes a vertical polarisation of the electric field, the horizontal electric field component of the surface wave propagation of the antenna being negligible by comparison, especially since the excitation loop is regular and substantially closed. The electric field lines are distributed substantially uniformly towards all of the azimuths about the axis Z1-Z1 of the loop, and this means that the antenna is omnidirectional.

Typically, the loop has a perimeter equal to half of the useful wavelength λ/2, ± approximately λ/8, or a length of L/2=λ/4 of the long sides I1p-I1n and S1 of approximately 25 m to 250 m for a hectometre central frequency of the useful band. In accordance with other embodiments, the shape of the excitation loop B1 is elongate and polygonal or elliptical, in such a way that two long portions such as the long sides I1p-I1n and S1 are substantially parallel in a plane substantially perpendicular to the surface SM of the conducting medium M. However, so as to radiate very few space waves in the direction of a central zenithal axis Z1-Z1 of the loop, the profile of the loop is constructed in such a way that the portions of the loop, such as the sides I1p-I1n and S1 of a rectangular loop, located substantially parallel to the surface SM and having dimensions at least greater than approximately λ/50, conduct currents of opposite directions.

The lower long side I1p-I1n is formed of two substantially collinear portions I1p and I1n between the mutually facing ends E1p and E1n of the loop B1, which define a small opening E1p-E1n, the width of which is very small by comparison with the wavelength λ. The opening E1p-E1n may be formed virtually anywhere along the long side I1p-I1n. In accordance with FIG. 1, the opening E1p-E1n is in the centre of the lower long side I1p-I1n. Bearing in mind the narrowness of the opening by comparison with the length of the loop, the loop is considered to be “closed”.

The excitation loop B1 may be held in a plane perpendicular to the surface SM by insulating posts (not shown) distributed evenly along the loop. For example, each post holds both of the long sides I1p-I1n and S1. The insulating posts may be fixed in the conducting medium M if the medium is of a suitable depth, or be fixed to a floating support on the surface SM if the medium is water.

In accordance with the intended application and the operating powers, the excitation loop B1 is in the form of a tube or a multi-strand or single-strand metal wire.

The conductive connection element L1n is substantially vertical and connects one E1n of the ends of the loop B1 to the conducting medium M at the opening E1p-E1n. The element L1n closes the loop B1 on the conducting medium M located on the surface SM. The element L1n may be formed by a pin or a metal tube, having a diameter of preferably between 5 and 50 mm, and having a lower end which dips a few tens of centimetres into the conducting medium M below the surface SM.

The physical form of the excitation loop and the connection element may also be embodied in accordance with other variants disclosed in patent application EP 1 594 186 A1, such as a net or a cage of parallel metal wires.

The connection element L1n may include a terminal impedance Zt, which is optional and may be replaced with a simple short circuit. The terminal impedance may be reactive or resistive. It may be controllable depending on the requirements so as to adjust the operating frequency of the antenna, corresponding to λ, to adjust the pass band of the antenna, or to adjust the input impedance of the antenna. The effect of the capacitive and/or inductive and/or resistive nature of the terminal impedance Zt on the operating features of the antenna, such as the operating frequency, the pass band and the impedance adaptation, is similar to the effect described in patent application EP 1 594 186 A1.

The power supply device A supplies the loop B1, and may he a transmission or reception device according to whether the antenna is in transmitting or receiving operation. In accordance with FIG. 1, the supply device A has positive and negative terminals connected to the ends E1p and E1n respectively of the loop B1 at the opening E1p-E1n, by one or two intermediate metal elements L2p and L2n as appropriate, which may be electrical wires or be of a similar form to the connection element L1n. In one particular embodiment, at least one of the intermediate elements L2p and L2n is of a zero length, and the corresponding terminal of the supply device A is connected directly to an end of the excitation loop B1.

In accordance with the second embodiment shown in FIG. 2, another conductive connection element L3n connects tie negative terminal of the supply device A to the conducting medium M located below the surface SM, as the second end of the connection element L1n which opposes the end E1n of the excitation loop B1 and dips into the conducting medium M below the surface SM. The lengths of the connection elements L2p and L3n are determined in such a way that the real part of the impedance of the antenna returned at the terminals of the supply device A is equal to the characteristic impedance of the supply device.

In variant embodiments shown in FIGS. 1 and 2, the antenna is used above an imperfect conducting medium M of low electrical conductivity, such as the earth or sand, located below the surface SM, as shown in FIGS. 3 and 4. In the variants, a metal earth element EM is buried close to and below the surface SM. The metal earth element EM is connected to the second end of the connection element L1n according to FIG. 3, corresponding to the first embodiment of the supply circuit, or at the ends of the connection elements L3n and L1n in The medium M according to FIG. 4, corresponding to the second embodiment of the supply circuit. The depth at which the earth element EM is buried below the surface SM is relatively small, approximately a few tens of centimetres, so as to promote a surface wave above the surface SM and inhibit any wave passing below the surface SM. The earth element EM may be a metal wire or rod or a solid or meshed plate, in accordance with the embodiments disclosed in patent application EP 1 594 186 A1. It provides excellent electrical continuity, so as to contribute to the omnidirectional nature of the antenna and thus maintain the surface wave radiation properties of the antenna. When the conducting medium M is in particular sea water, the earth element P may be made of galvanised metal or coated in a plastic sheath, and be resistant to chemical attacks in the medium M.

The earth element EM may have various contours of the circular or polygonal type, so as to cover a surface area at leant equal to, or even much greater than, the projection of the surface of the excitation loop onto the surface SM. This feature prevents electric field edge effects between the excitation loop and the earth element, and improves the confinement of the electric field lines below the excitation loop. For an excitation loop which extends in a vertical plane XOZ, as shown in FIGS. 3 and 4, the planar element EM is of a length at least equal to the length L/2 of the long sides I1p-I1n and S1 of the loop B1, or greater than approximately half the length of the loop, and a width of at least a few tens of centimetres.

In accordance with a variant of the first embodiment of the loop B1, at least one intermediate metal element Vip, Vin is connected, for example by welding, to the long sides I1p-I1n and S1 of the excitation loop B1, as shown in FIG. 5. The intermediate metal element is substantially perpendicular to the long sides, and may be of a similar form to the loop B1. In a variant, one or more intermediate elements Vip are placed in a single side of the loop B1 with respect to the opening E1p-E1n of the loop, and/or one or more intermediate elements Vin are placed in the other side of the loop with respect to the opening. The intermediate metal elements Vip and Vin are located close to the longitudinal ends of the excitation loop B1, for example a few metres away from the short sides V1p and V1n. The intermediate elements are intended to broaden the pass band of the antenna around the resonant frequency of the antenna, without significantly altering the radiation features of the antenna.

Although the antennae disclosed in the following and shown in FIGS. 8 to 18 comprise a supply circuit in accordance with the first embodiment shown in FIG. 1, the supply circuits shown in FIGS. 2, 3 and 4 are suitable for supplying the excitation loops of these antennae. Each of these excitation loops may comprise one or more intermediate elements, such as the elements Vip and Vin shown in FIG. 5, between lower and upper portions of the excitation loop, or more generally between the lower and upper “half” loops of the excitation loop, so as to broaden the pass band of the antennae.

Referring now to FIGS. 6 to 8, the excitation loop B2 of an antenna in accordance with the second embodiment is based on folding a first half of the excitation loop B1, comprising the portion I1n of the lower long side, the short side V1n and half of the upper long side S1, towards the second half of the loop B1 about the central zenithal axis Z1-Z1 of the loop B1, as shown by the arrow F2 in FIG. 5. The loop B2 thus comprises, approximately speaking, two “half” loops on the front (FIG. 7) and rear faces or the lower and upper faces of a long, thin, substantially right parallelepiped. This parallelepiped which encloses the loop B2 is of a length of approximately L/4 and a height of H−h. The parallelepiped extends not only longitudinally along a vertical plane XOZ (FIG. 7), but also laterally along a vertical plane YOZ (FIG. 8) perpendicular to the plane XOZ. Two upper longitudinal portions S2p and S2n of the loop B2, which correspond to the two halves of the upper portion S1 of the loop B1, are connected via a short horizontal portion S21p. The end of the lower portion I2n of the loop B2, which corresponds to the upper portion I1n of the loop B1 pulled back towards the rear, is connected via a short horizontal portion I21n, which is parallel to the portion S21p and located together therewith on a lateral vertical edge of the parallelepiped.

From the end E2p of the excitation loop B2 which is connected to the positive terminal of the supply device A, the loop B2 comprises a long lower longitudinal portion I2p, a short vertical portion V2p of height H−h, a long upper longitudinal portion S2p located above the portion I2p and defining together with the portions I2p and V2p the front face of the parallelepiped, it short lateral portion S21p, a long upper longitudinal portion S2n defining together with the portions S2p and S21p the upper face of the parallelepiped, a short vertical portion V2n of height H−h located together with the short portion V2p in a plane perpendicular to the longitudinal portions, a long lower longitudinal portion I2n located below the portion S2n and defining together with the portions S2n and V2n the rear face of the parallelepiped, and a short lateral portion I21n located below the portion S21p, defining together with the portions I2p and I2n the lower face of the parallelepiped and terminated by the other end E2n of the excitation loop B2.

The length of the substantially horizontal lateral portions I21n and S21p defines the width W of the loop B2 in a vertical plane YOZ, which is much less than λ in such a way that the two parallel portions located in each of the longitudinal faces of the parallelepiped are flowed through substantially by currents of opposite directions. Linder these conditions, the secondary components of the electric field which are generated in the horizontal planes are greatly suppressed in directions close to the central zenithal axis Z2-Z2 of the loop B2. However, the length of the lateral portions I21n and S21p is at least equal to approximately λ/200 so as to prevent excessively strong couplings between the longitudinal portions I2p and I2n and S2p and S2n, which lead to a significant reduction in the efficiency of the antenna. In this case, the end winding of the folded excitation loop B2 is longer than the end winding of the excitation loop B1. For a given resonant frequency, the length of the end winding of the folded loop B2 shown in FIG. 6 is a function of the length of the portions I21n and S21p. The pass band is also reduced, as a result of the increase in the quality factor of the antenna. However, this reduction in the pass band can be compensated by adding metal intermediate elements Vip between the lower I2p and upper S2p portions and/or metal elements Vin between the lower I2n and upper S2n portions, such as those shown in FIG. 5.

The principle of folding the excitation loop onto itself, as shown in FIGS. 6 to 8, can be extended to multiple successive folds, leading to a proportional increase in the end winding of the antenna and a reduction of the pass band for a given resonant frequency.

Referring to FIGS. 9 to 12, the excitation loop B3 of an antenna in accordance with the third embodiment is based on folding the thirds located to the left and right of the loop B1 in FIG. 5 towards the front and rear respectively of the central third of the loop B1. The left third of the excitation loop B3 is located in a front vertical plane located in front of the central third of the loop B1 after folding about a zenithal axis of the loop B1 located at the left end of the central third, as shown by the arrow F3p in FIG. 5. The right third of the excitation loop B3 is located in a rear vertical plane located behind the central third of the loop B1 after folding about a zenithal axis of the loop B1 located at the right end of the central third, as shown by the arrow F3n in FIG. 5. The excitation loop B3 in accordance with the third embodiment thus comprises, approximately speaking, three thirds I3p-S3p (FIG. 11). I3cp-I3cn-S3c and I3n-S3n of a loop on each of the front, central and rear faces of a thin, substantially right parallelepiped. This parallelepiped, enclosing the loop B3, is of a length of approximately L/6 and a height H−h. The loop B3 is formed, approximately speaking, of two “half” loops I3p-I3cp-I3cn-I3n and S3p-S3c-S3n (FIG. 11) on each of the lower and upper large horizontal lower faces of the long parallelepiped. A left end of the front lower portion I3p of the loop B2, corresponding to the left third of the lower portion I1p of the loop B1 folded towards the front, and a left end of the front upper portion S3p of the loop B2, corresponding to the left third of the upper portion S1p of the loop B1 folded towards the front. are connected by two short horizontal lateral portions I31p and S32p respectively, which are parallel and located in a left vertical edge of the parallelepiped. A right end of the rear lower portion I3n of the loop B2, corresponding to the right third of the lower portion I1n of the loop B1 folded towards the rear, and a right end of the front upper portion S3n of the loop B2, corresponding to the right third of the upper portion S1p of the loop B1 folded towards the rear, are connected by two short horizontal lateral portions I31n and S31n respectively, which are parallel and located in a right vertical edge of the parallelepiped. From the end E3p of the excitation loop B3 connected to the positive terminal of the supply device A, the loop B3 comprises the lower central longitudinal “half” portion I3cp, the lower lateral short portion I31p, the longitudinal front lower long portion I3p, a short vertical portion V3p of height H−h, the longitudinal front upper long portion S3p, the upper lateral shot portion S31p, the longitudinal central upper long portion S3c, the upper lateral short portion S31n, the longitudinal rear upper long portion S3n, a short vertical portion V3n of height H−h, the rear lower long portion I3n, the lower lateral short portion I31n, and the tower central horizontal longitudinal “half” portion I2n terminated by the other end E3n of the excitation loop B3.

The length of the horizontal lateral portions I31p, I31n, S31p and S31n defines the half-width W of the loop B3 in a vertical plane YOZ, which is between λ/200 and λ/50 and therefore much less than λ, in such a way that the two parallel longitudinal portions located in each of the three front, intermediate and rear longitudinal faces, and two adjacent longitudinal portions out of three located in each of the central and upper longitudinal faces of the parallelepiped, are flowed through substantially by currents of opposite directions. However, in a variant, the length of the superposed lateral portions I31p and S31p may be different from the length of the superposed lateral portions I31n and S31p, and the vertical face containing the parallel longitudinal portions I3cp, I3cn and S3c may be at different distances from the front and rear faces. These conditions optimise the radiation efficiency of the antenna and minimise the transmission or reception of the electromagnetic field in directions close to the central zenithal axis of the antenna.

Instead of dividing the longitudinal portions in the lower and upper faces in a zigzag, as in the loop B3, the excitation loop B4 of an antenna in accordance with the fourth embodiment shown in FIGS. 13 to 15 comprises, approximately speaking, a lower “half” loop, formed by two flat rectangular spirals I4p and I4n having opposite directions and a shared centre, and an upper “half” loop, formed by two flat rectangular spirals S4p and S4n having opposite directions and a shared centre. The half loops I4p-I4n and S4p-S4n are circumscribed on the lower and upper large faces respectively of a substantially right parallelepiped of height H−h, length 5×p1 and width 4×p2 in accordance with the example shown in FIG. 14. The longitudinal pitch p1 and the lateral pitch p2 of the turns of the spirals may a priori be different and are much smaller than λ, for example between λ/120 and λ/80. The lower and upper large faces of the parallelepiped are substantially parallel to the surface SM of the conducting means M. The upper spirals S4p and S4n are superposed substantially vertically on the lower spirals I4p and I4n respectively. Short vertical portions V4p and V4n of the excitation loop B4 are of a height H—h and connect the peripheral ends of the spirals I4p and S4p and the peripheral ends of the spirals I4n and S4n respectively. In the embodiment shown in FIGS. 13 to 15, the ends E4p and E4n of the opening of the loop B4 located in the centre of the half-loop I4p-I4n, the lower spirals I4p and I4n and the upper spirals S4p and S4n are symmetrical about a central zenithal axis Z4-Z4 of the loop B4 passing through the centres of the spirals and of the lower and upper faces of the parallelepiped respectively.

In each of the lower and upper large faces of the parallelepiped, the property is maintained whereby two adjacent longitudinal or transverse portions of the half-loops are flowed through by currents of opposite directions. The reduction in the size of the excitation loop B4 by rolling the loop up onto itself is reduced by more than in the preceding loops.

In a variant, instead of the pitch being constant, it may be variable for example so as to form logarithmic lower and upper spirals of the loop. More generally, a variable pitch for each turn of the half-loops may be selected so long as the restrictions on the distance between the turns are met so as to maintain a high radiating efficiency comparable with that of the loops B2 and B3 which are obtained by folding.

The loop B5 in accordance with the fifth embodiment shown in FIGS. 15 to 18 comprises, approximately speaking, a lower half-loop formed by two flat circular Archimidean spirals I5p and I5n having opposite directions and a shared centre, and a lower half-loop formed by two flat circular Archimidean spirals S5p and S5n having opposite directions and a shared centre. The half-loops I5p and Isn, and S5p and S5n are circumscribed on the lower and upper bases respectively of a cylinder having a height of H−h, a radius p and a zenithal axis Z5-Z5 passing through the centres of the spirals and of the opening E5p-E5n of the loop B5 located at the centre of the lower half loop I5p-I5n. The bases of the cylinder are substantially parallel to the surface SM of the conducting medium M and are for example circular or elliptic, or else the cylinder is replaced with a prism having polygonal bases. Short vertical portions V5p and V5n of the excitation loop B5 are of a height H−h and connect peripheral ends of the spirals I5p and S5p and peripheral ends of the spirals I5n and S5n respectively.

1. Surface-wave antenna, comprising a metal excitation loop (B1) which can be positioned at a height (h) of at least 1 m above the surface (SM) of a conducting medium (M) and a supply means (A, L1n) which can be connected to the conducting medium, the loop being of a length of approximately λ/2 and λ representing the operating wavelength of the antenna, wherein the excitation loop (B1) comprises two substantially parallel portions (I1p-I1n-S1) which are at most approximately λ/50 apart and can extend substantially parallel to the surface (SM) of the conducting medium (M) in a plane substantially perpendicular to said surface and can be flowed through by currents of opposite directions, the portion (I1p-I1n) closest to said surface comprising an opening between ends (E1p, E1n) of the loop (B1) which are connected to the supply means (A, L1n).

2. Antenna according to claim 1, wherein the excitation loop (B1) is rectangular and comprises two long sides formed by said two portions (I1p-I1n, S1) and of a length of at most approximately λ/4.

3. Antenna according to claim 1, wherein the excitation loop (B2) is divided approximately into two half-loops which are superposed on two planes which are substantially parallel to the surface (SM) of the conducting medium (M), are at most λ/50 apart, and each have two substantially parallel portions (I2p, I2n; S2p, S2n) which can be flowed through by currents of opposite directions.

4. Antenna according to claim 3, wherein each of the half-loops comprises more than two substantially parallel portions (I3p, I3cp-I3cn, I3n; S3p, S3c, S3n; or I4p, I4n; S4p, S4n; or I5p, I5n; S5p, S5n), it being possible for two adjacent portions in each half-loop to be flowed through by currents of opposite directions and for two superposed portions of the half-loops to be flowed through by currents of opposite directions.

5. Antenna according to claim 4, wherein the excitation loop (B3) is circumscribed on a parallelepiped having large faces substantially parallel to the surface (SM) of the conducting medium (M), and each of the half loops (I3p-I3cp-I3cnI3n, S3p-S3c-S3n) extends in a zigzag on one of the large faces.

6. Antenna according to claim 4, wherein the excitation loop (B4) is circumscribed on a parallelepiped piped having large faces substantially parallel to the surface (SM) of the conducting medium (M), and each of the half-loops comprises two flat rectangular spirals (I4n, I4n; S4p, S4n) having opposite directions and a shared center and extending on one of the large faces.

7. Antenna according to claim 4, wherein the excitation loop (B5) is circumscribed on a cylinder having bases which are substantially parallel to the surface (SM) of the conducting medium (M), and each of the half-loops comprises two flat circular spirals (I5p, I5n; S5p, S5n) having opposite directions and a shared centre and extending on one of the bases.

8. Antenna according to claim 1, wherein two substantially parallel, superposed and adjacent portions (I1p-I1n; S1; I2p, I2n; S2p, S2n) of the excitation loop (B1, B2) are at least approximately λ/200 apart.

9. Antenna according to claim 1, comprising at least one metal intermediate element (Vip; Vin) which is connected to portions (I1p-I1n, S1) of the excitation loop (B1), which are superposed in a plane which can be substantially perpendicular to the surface (SM) of the conducting medium (M) and is located close to short sides (V1p, V1n) of the excitation loop (B1) which substantially perpendicular to the superimposed portions.

10. Antenna according to claim 1, wherein the supply means comprises a power supply device (A), having positive and negative terminals which are connected to the ends (E1p, E1n) of the loop (B1), and a connection element (L1n), having one end connected to the negative terminal of the supply device and another end which can be connected to the conducting medium (M).

11. Antenna according to claim 1, wherein the supply means comprises a metal connection element (L1n), having one end connected to one (E1n) of the ends of the loop (B1) and another end which can be connected to the conducting medium (M), a power supply device (A) having a positive terminal connected to the other end (E1p) of the loop, and a metal connection element (L3n), having one end connected to a negative terminal of the supply device and another end which can he connected to the conducting medium (M).

12. Antenna according to claim 10, wherein the end of a metal connection element (L1n; L3n) which can he connected to the conducting medium (M) can be connected to a metal earth element (EM) buried close to and below the surface (SM) of the conducting medium (M) and having a surface area at least equal to the projection of the surface of the excitation loop (B1) onto the surface of the conducting medium.
